(19) United States
(12) Patent Application Publication
(10) Pub. No.: US 2022/0410422 A1
(43) Pub. Date: Dec. 29, 2022

(54) SAFETY RAZOR

(71) Applicant: 2217176 ONTARIO INC., Kitchener (CA)

(72) Inventors: Brad Jantzi, Kitchener (CA); Kevin Enter, Kitchener (CA)

(21) Appl. No.: 17/360,650

(22) Filed: Jun. 28, 2021

(51) Int. Cl. B26B 21/18; B26B 21/52; B26B 21/40

(52) U.S. Cl. CPC B26B 21/18; B26B 21/521; B26B 21/4025; B26B 21/4031

(57) ABSTRACT

A safety razor including a handle; a base plate having an upper surface; and a top cap having a lower surface. The top cap configured to be secured to the base plate to hold a removeable double-edged razor blade between the upper surface and the lower surface, with the handle extending from the joined base plate and top cap for use in manipulating the joined base plate and top cap.

### FIELD

The specification relates generally to razors, and more specifically to safety razors.

### BACKGROUND

U.S. Pat. No. 775,134 to Gillette (“Gillette”) purports to disclose a safety razor for use with a razor of very thin sheet steel. Gillette purports to disclose a blade holder so constructed as to provide a rigid backing and support for the blade, as well as a handle therefore, so that although the blade itself is readily flexible by reason of its thinness and lacks the rigidity of other razor blades, yet when it is combined with its holder it receives a degree of rigidity sufficient to make it practically operative.

U.S. Pat. No. 3,748,735 to Whittington (“Whittington”) purports to disclose a safety razor wherein a forward or leading end of the usual type handle is provided with a reduced offset shank disposed at an angle oblique to the longitudinal axis of the handle. Whittington purports to disclose that this shank functions to accommodate an attachable and detachable head made up of a guard plate and a complemental clamping plate. Whittington purports to disclose that central portions of these plates are provided with aligned openings or holes. Whittington purports to disclose that the hole in the clamping plate is threaded to accommodate the screw-threaded shank, and the threads on the shank also serve to accommodate a knurled collar-type nut which is manually adjustable to maintain the over-all head in an advantageous keen cutting but safe position.

U.S. Pat. No. 9,505,142 to Nordstrom (“Nordstrom”) purports to disclose a safety razor for personal grooming. Nordstrom purports to disclose that the safety razor includes a handle, a cap, and a base plate that has blade-engaging surfaces that define the razor blade angle when clamped between the cap and the base plate. Nordstrom purports to disclose that the base plate can be double-sided to provide a second angled blade-engaging surface that defines a second razor blade angle when the razor blade is clamped between the second side of the base plate and the cap. Nordstrom purports to disclose that the modular base plate allows a shaver to replace or flip, in the case of double-sided base plates, the base plate in order to change the blade angle and the aggressiveness of the shave from the safety razor.

### SUMMARY

The following summary is intended to introduce the reader to various aspects of the applicant's teaching, but not to define any invention.

According to some aspects, there is provided a safety razor, comprising a handle; a base plate having an upper surface; and a top cap having a lower surface with a lateral portion having a concave cap curvature, the cap curvature having a cap radius of less than 15 millimeters, the top cap configured to be secured to the base plate to hold a removeable double-edged razor blade between the upper surface and the lower surface, with the handle extending from the joined base plate and top cap for use in manipulating the joined base plate and top cap, and wherein the base plate and the top cap are shaped to hold the removeable double-edged razor blade between the upper surface and the lower surface such that a lateral portion of the razor blade takes on a blade curvature having a blade radius approximately equal to the cap radius.

In some examples, the upper surface of the base plate has a lateral portion having a convex plate curvature, the convex plate curvature having a plate radius approximately equal to the cap radius.

In some examples, the base plate and the top cap are shaped to hold the razor blade between the upper surface and the lower surface such that an edge-bearing portion of the blade is deflected by an angle of at least 20 degrees relative to a central portion of the razor blade.

In some examples, the base plate and the top cap are shaped to hold the razor blade between the upper surface and the lower surface such that a central portion of the razor blade is planar.

In some examples, the razor blade has a width of less than 30 millimeters and the base plate and the top cap are shaped to hold the razor blade between the upper surface and the lower surface such that the clamp distance is less than 3 millimeters.

In some examples, the razor blade has a width of less than 30 millimeters and the base plate and the top cap are shaped to hold the razor blade between the upper surface and the lower surface such that the free-end distance is less than 1 millimeter.

In some examples, the razor blade has a width of less than 30 millimeters and the base plate and the top cap are shaped to hold the razor blade between the upper surface and the lower surface such that a blade exposure is less than 0.075 millimeters.

In some examples, the base plate and the top cap are shaped to hold the razor blade between the upper surface and the lower surface such that the blade gap is between 1 millimeter and 0.5 millimeters.

In some examples, the base plate and the top cap are shaped to hold the razor blade between the upper surface and the lower surface such that the guard span is less than 1 millimeter.

In some examples, the base plate and the top cap are shaped to hold the razor blade between the upper surface and the lower surface such that the guard span is less than two times the size of the blade gap.

According to some aspects, there is provided a safety razor, comprising a handle; a base plate having an upper surface and a plate lateral surface; and a top cap having a lower surface and a cap lateral surface, the top cap configured to be secured to the base plate to hold a removeable double-edged razor blade between the upper surface and the lower surface, with the handle extending from the joined base plate and top cap for use in manipulating the joined base plate and top cap, and wherein the base plate and the top cap are shaped to hold the removeable double-edged razor blade between the upper surface and the lower surface such that the safety razor has a shave plane parallel to the cap lateral surface and tangential to the plate lateral surface, and wherein the cap lateral surface has a height that is at least twice the size of the blade gap.

In some examples, the plate lateral surface is also planar, and the base plate and the top cap are shaped to hold a removeable double-edged razor blade between the upper surface and the lower surface such that the plate lateral surface is not parallel to the cap lateral surface.

In some examples, the base plate and the top cap are shaped to hold a removeable double-edged razor blade between the upper surface and the lower surface such that a plane parallel to the plate lateral surface is angled by less than 5 degrees relative to a plane parallel to the cap lateral surface.

In some examples, the razor blade has a width of less than 30 millimeters and the base plate and the top cap are shaped to hold the razor blade between the upper surface and the lower surface such that a blade exposure is between 1 millimeter and 0.01 millimeters.

In some examples, the base plate and the top cap are shaped to hold the razor blade between the upper surface and the lower surface such that the guard span is less than 1.25 millimeters.

According to some aspects, there is provided a safety razor, comprising a handle; a top cap having a lower surface and a retention feature to receive a portion of the handle; a base plate having an upper surface; a thrust bushing insert received in an opening in the base plate; and wherein the base plate and the top cap are shaped to hold a removeable double-edged razor blade between the upper surface and the lower surface when drawn together, and to be drawn together by tightening the portion of the handle onto the retention feature and against the thrust bushing insert, and wherein the thrust bushing insert is made of a first material and the portion of the handle is made of a second material different from the first material.

In some examples, the first and second materials are each metals.

In some examples, one of the first and second materials is mainly tungsten.

In some examples, the first material is mainly tungsten.

In some examples, the second material is mainly one of aluminum, brass, stainless steel, and titanium.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a top perspective view of a safety razor;

FIG. 2 is a bottom perspective view of the safety razor of FIG. 2;

FIG. 3 is a top plan view of a razor blade;

FIG. 4 is a side view of a cross section of a portion of the safety razor of FIG. 1;

FIG. 5 is a perspective view of the cross section of the portion of the safety razor shown in FIG. 4;

FIG. 6 is a top perspective view of a base plate of the safety razor of FIG. 1;

FIG. 7 is a side view of the base plate of FIG. 6;

FIG. 8 is a bottom plan view of the base plate of FIG. 6;

FIG. 9 is a bottom perspective view of a top cap of the safety razor of FIG. 1; and

FIG. 10 is a side view of the top cap of FIG. 9.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or process described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

Although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the examples described herein may be practiced without these specific details. In other instances, well-known methods, procedures, and components have not been described in detail so as not to obscure the examples described herein.

As used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

### General Description of a Safety Razor

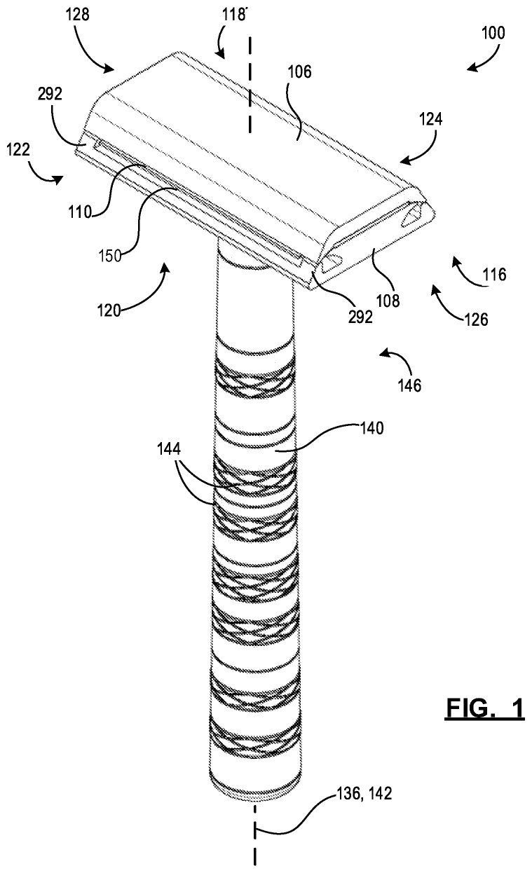

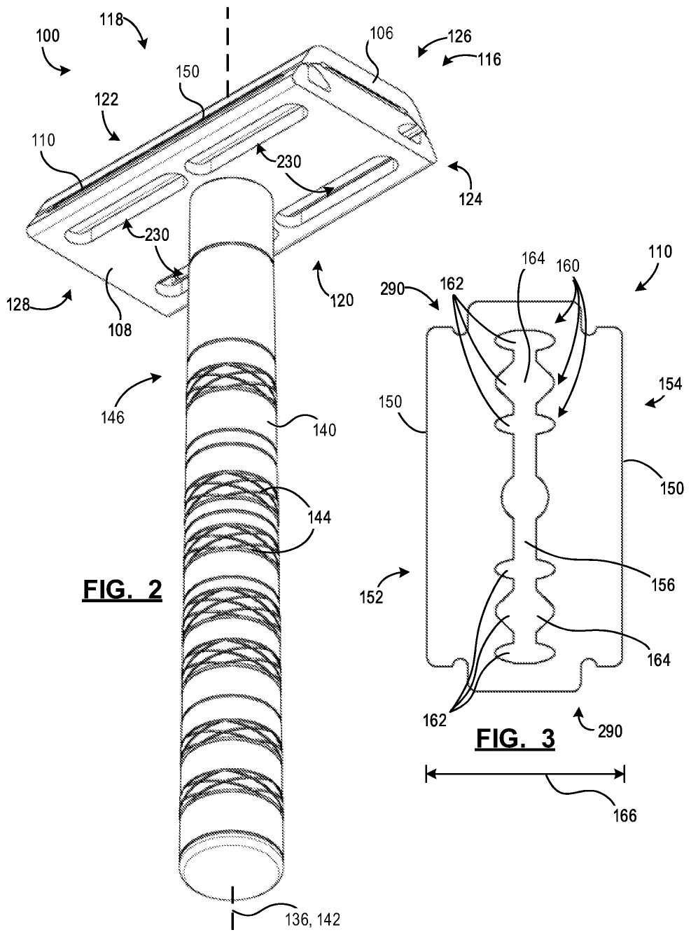

As exemplified in FIGS. 1 to 3, a safety razor 100 has a top cap 106 and a base plate 108. The top cap 106 and the base plate are shaped to hold a razor blade 110 between the top cap 106 and the base plate 108, and may be joined together to hold the razor blade 110 therebetween.

The joined top cap 106 and base plate 108 form a razor head 116, with or without the razor blade 110 held between the top cap 106 and the base plate 108. The razor head 116 has a top end 118, a bottom end 120, a front end 122, a rear end 124, a right lateral end 126, and a left lateral end 128. A vertical axis 136 extends between the top end 118 and the bottom end 120.

A handle 140 extends from the joined top cap 106 and base plate 108. The handle 140 extends from the bottom end 120 of the razor head 116. In some examples, as in the illustrated example, the handle 140 generally extends along a vertical centre line 142 of the razor head 116 (e.g., parallel to the vertical axis 136). In some examples, as in the illustrated example, the handle 140 holds the top cap 106 and the base plate 108 together (i.e., holds the head 116 together), as will be described further below. The handle 140 may be used to manipulate the joined top cap 106 and base plate 108 (e.g., to apply the joined top cap 106 and base plate 108 to a face of a user). In some examples, the handle 140 includes knurling 144 (e.g., to facilitate a better grip of the user on the handle 140). In some examples, the handle 140 includes a slight taper on the proximal end 146 (e.g., the diameter of the handle 140 increases farther from the head 116).

As exemplified in FIG. 3, the razor blade 110 is a dual sided razor blade 110 with a blade edge 150 on each of a front end 152 and a rear end 154 of the razor blade 110. It will be appreciated that the safety razor 100 may be used with a variety of types of razor blades 150. In some examples, the safety razor 100 is used with a razor blade 110 that includes an elongated transverse slot 156 therethrough from the top surface to the bottom surface of the blade 110. In some examples, the elongated transverse slot 156 is used to position the razor blade 110 in the head 116 (i.e., guide the positioning of the blade 110 when assembling the head 116) and/or hold the razor blade 110 in position in the assembled head 116, as will be described further below.

It will be appreciated that in some examples, the razor blade 110 also has one or more further positioning features 160, as exemplified in FIG. 3. For example, the razor blade 110 may include a plurality of longitudinal slots 162 therethrough. The plurality of longitudinal slots 162 may include a pair of diamond shaped slots 164 (e.g., for receiving round locator pins).

The razor blade 110 may have a width 166 of between 10 and 30 millimeters. The razor blade 110 may have a width 166 of between 15 and 25 millimeters. The razor blade 110 may have a width 166 of about 22 millimeters.

In some examples, as in the illustrated example, the razor head 116 is shaped to hold only a single razor blade 110 (i.e., the safety razor 100 does not include and/or cannot hold a plurality of razors in the manner of a cartridge razor).

### Clamp Distance

In accordance with this aspect, the safety razor 100 is shaped to hold the razor blade 110 in position in the assembled head 116 with a short clamp distance 170. This aspect may be used by itself or in combination with one or more of the other aspects set out herein.

An advantage of this aspect is that the razor blade 110 may be held more rigidly than when held with a larger clamp distance 170. The razor blade 110 held with a short clamp distance 170 may have reduced chatter.

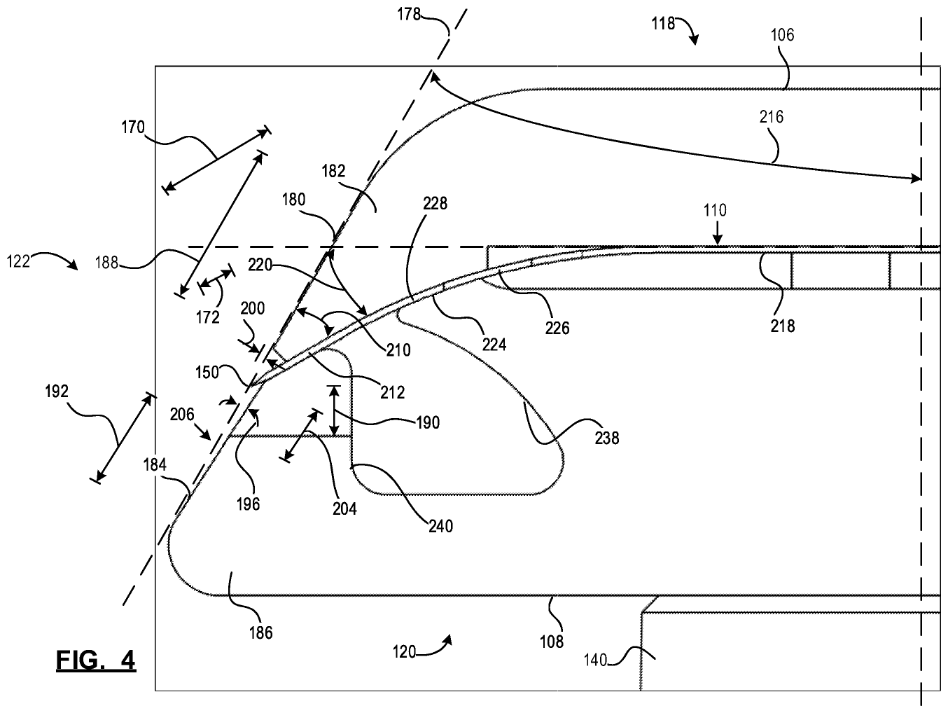

As exemplified in FIG. 4, the clamp distance 170 is the distance between the blade edge 150 of the razor blade 110 and the position where the top cap 106 and the base plate 108 clamp the blade 110 when the blade 110 is received in the assembled head 116.

In some examples, the clamp distance 170 is less than 10 millimeters. In some examples, the clamp distance 170 is less than 5 millimeters. In some examples, the clamp distance 170 is less than 2.75 millimeters. In some examples, the clamp distance 170 is more than 1 millimeter. In some examples, the clamp distance 170 is between 1 millimeter and 2.75 millimeters. In some examples, the clamp distance 170 is between 1.6 millimeters and 2.7 millimeters. In some examples, the clamp distance 170 is about 2.2 millimeters.

### Free-End Distance

In accordance with this aspect, the safety razor 100 is shaped to hold the razor blade 110 in position in the assembled head 116 with a short free-end distance 172. This aspect may be used by itself or in combination with one or more of the other aspects set out herein.

An advantage of this aspect is that the razor blade 110 may be held more rigidly than when held with a larger free-end distance 172. The razor blade 110 held with a short free-end distance 172 may have reduced chatter.

As exemplified in FIG. 4, the free-end distance 172 is the distance between the blade edge 150 of the razor blade 110 and the position of first contact with the top cap 106 when the blade 110 is received in the assembled head 116.

In some examples, the free-end distance 172 is less than 5 millimeters. In some examples, the free-end distance 172 is less than 2 millimeters. In some examples, the free-end distance 172 is less than 1 millimeter. In some examples, the free-end distance 172 is between 0.5 millimeters and 1 millimeter. In some examples, the free-end distance 172 is between 0.45 millimeters and 0.95 millimeters. In some examples, the free-end distance 172 is about 0.7 millimeters.

### Shave Plane

In accordance with this aspect, the safety razor 100 is shaped to hold the razor blade 110 in position in the assembled head 116 with a shave plane 178 formed of mostly flat surfaces. This aspect may be used by itself or in combination with one or more of the other aspects set out herein.

An advantage of this aspect is that the razor blade 110 may be more easily positioned for reliable and/or secure contact. A shave plane formed of mostly flat surfaces may minimize the chance of undesired contact between skin of a user and the razor blade 110. A shave plane formed of mostly flat surfaces may allow for other features of the safety razor 100 to be configured more aggressively, such as with a larger blade exposure and/or blade gap. The safety razor 100 with a shave plane formed of mostly flat surfaces may have more aggressively configured features (which may be more effective) while still being experienced by a user as a mild or medium aggression safety razor.

A shave plane 178 of the safety razor 100 is a plane that is tangential to the top cap 106 and the base plate 108 on a lateral side. As exemplified in FIG. 4, the safety razor 100 forms a shave plane 178 that is coplanar with a cap lateral surface 180 of a lateral portion 182 of the top cap 106 and intersects a plate lateral surface 184 of a lateral portion 186 of the base plate 108.

The cap lateral surface 180 of the top cap 106 is a planar surface. The cap lateral surface 180 may have a height 188 that is larger than a blade gap 190 (described below). The height 188 of the cap lateral surface 180 may be more than two times the size of the blade gap 190. The height 188 may be more than 3 times the size of the blade gap 190. The height 188 may be about 3.1 times the size of the blade gap 190.

The plate lateral surface 184 of the base plate 108 may be a planar surface. The plate lateral surface 184 of the base plate 108 may have a height 192. The height 192 of the plate lateral surface 184 may be larger than the blade gap 190. The height 192 may be about the size of the blade gap 190. The height 192 may be more than 1.5 times the blade gap 190. The height 192 may be about 1.6 times the blade gap 190.

As in the illustrated example, the cap lateral surface 180 and the plate lateral surface 184 may not be coplanar. The plate lateral surface 184 may extend at an angle 196 out of the plane of the cap lateral surface 180. In some examples, the angle 196 is less than 10 degrees. In some examples, the angle 196 is less than 5 degrees. In some examples, the angle 196 is between 2.5 and 3 degrees.

### Blade Exposure

In accordance with this aspect, the safety razor 100 is shaped to hold the razor blade 110 in position in the assembled head 116 with a large blade exposure 200. The blade exposure 200 may be larger than normal for the level of aggressiveness of the safety razor 100. This aspect may be used by itself or in combination with one or more of the other aspects set out herein.

An advantage of this aspect is that the safety razor 100 may be more effective and/or user-friendly than a razor with a similar blade exposure and/or level of aggressiveness.

Referring to FIG. 4, the blade exposure 200 is the distance that the blade edge 150 extends out of the shave plane. The blade exposure 200 may be positive or negative. The blade exposure 200 may be negative for some safety razors 100 with a very mild aggression (i.e., to reduce the chance of nicks, razor burn, and/or general irritation). A larger blade exposure 200 may be generally associated with a more aggressive safety razor 100.

The blade exposure 200 may be more than 0.005 millimeters. The blade exposure 200 may be more than 0.01 millimeters. The blade exposure 200 may be more than 0.015 millimeters. The blade exposure 200 may be between 0.015 millimeters and 0.06 millimeters. The blade exposure 200 may be about 0.025 millimeters. The blade exposure 200 may be about 0.05 millimeters.

### Blade Gap

In accordance with this aspect, the safety razor 100 is shaped to hold the razor blade 110 in position in the assembled head 116 with a large blade gap 190. The blade gap 190 may be larger than normal for the level of aggressiveness of the safety razor 100. This aspect may be used by itself or in combination with one or more of the other aspects set out herein.

An advantage of this aspect is that the safety razor 100 may be more effective and/or user-friendly than a razor with a similar blade gap and/or level of aggressiveness.

Referring to FIG. 4, the blade gap 190 is the distance between the blade edge 150 and the base plate 108 below the blade edge 150. A larger blade gap 190 may be generally associated with a more aggressive safety razor 100.

The blade gap 190 may be more than 0.5 millimeters. The blade gap 190 may be more than 0.6 millimeters. The blade gap 190 may be between 0.5 millimeters and 1 millimeter. The blade gap 190 may be between 0.6 millimeters and 0.9 millimeters. The blade gap may be about 0.68 millimeters. The blade gap 190 may be about 0.85 millimeters.

### Guard Span

In accordance with this aspect, the safety razor 100 is shaped to hold the razor blade 110 in position in the assembled head 116 with a small guard span 204. The guard span 204 may be smaller than normal for the size of the blade gap and/or level of aggressiveness of the safety razor 100. This aspect may be used by itself or in combination with one or more of the other aspects set out herein.

An advantage of this aspect is that the safety razor 100 may be less aggressive and/or more user-friendly with a smaller guard span 204. The guard span 204 may be more influential on the level of aggression of the safety razor 100 than the blade gap 190.

As exemplified in FIG. 4, the guard span 204 is the distance between the blade edge 150 and the safety bar or guard 206. The guard span 204 may be the distance between the blade edge 150 and the lateral surface 184 of the base plate 108. The guard span 204 may form the effective gap into which skin of the user can deform in front of and/or into the blade.

The guard span 204 is relatively small compared to the blade gap 190 due to the position of the blade edge 150 farther out laterally. In some examples, the guard span 204 is less than two times the size of the blade gap 190. In some examples, the guard span 204 is less than 1.5 times the blade gap 190. In some examples, the guard span 204 is less than 1.2 times the blade gap 190. In some examples, the guard span 204 is about 1.1 times the blade gap 190.

In some examples, the guard span 204 is less than 2 millimeters. In some example, the guard span 204 is less than 1.5 millimeters. In some examples, the guard span 204 is less than 1.1 millimeters. In some examples, the guard span 204 is less than 0.9 millimeters. In some examples, the guard span 204 is between 1.1 and 0.65 millimeters. In some examples, the guard span 204 is about 0.92 millimeters. In some examples, the guard span 204 is about 0.75 millimeters.

### Blade Angle

In accordance with this aspect, the safety razor 100 is shaped to hold the razor blade 110 in position in the assembled head 116 with a blade angle 210 of between 15 and 45 degrees, between 25 and 35 degrees, or about 30 degrees. Such a blade angle 210 may facilitate user comfort. This aspect may be used by itself or in combination with one or more of the other aspects set out herein.

As exemplified in FIG. 4, the blade angle 210 is the effective angle of the blade as it makes contact with the skin. The blade angle 210 may be the angle 210 between the shave plane 178 and an edge portion 212 of the blade 110.

### Shave Angle

In accordance with this aspect, the safety razor 100 is shaped to hold the razor blade 110 in position in the assembled head 116 with a shave angle 216 of less than 45 degrees, between 25 and 45 degrees, between 25 and 35 degrees, or about 30 degrees. Such a shave angle 216 may facilitate user comfort. This aspect may be used by itself or in combination with one or more of the other aspects set out herein.

As exemplified in FIG. 4, the shave angle 216 is the effective angle between the handle 140 and the shave plane 178. Up to a point, a lesser shave angle 216 (e.g., less than 45 degrees) may make for an easier shave (e.g., more stable and/or more controllable).

### Blade Deflection

In accordance with this aspect, the safety razor 100 is shaped to bend the razor blade 110 to allow for a desirable blade angle 210 and a desirable shave angle 216. This aspect may be used by itself or in combination with one or more of the other aspects set out herein.

The blade 110 may be clamped against a curved surface and/or between curved surfaces (e.g., to hold the blade securely). The blade 110 may be bent over a distance that facilitates holding the blade 110 securely.

As exemplified in FIG. 4, the blade 110 is held in the head 116 such that a central portion 218 of the blade extends in a plane perpendicular to the vertical axis 136 (e.g., perpendicular to the handle 140). The blade 110 is then bent by an angle 220 of more than 10 degrees out of that plane (i.e., the blade edge 150 is deflected down). The blade 110 may be bent by more than 20 degrees. The blade 110 may be bent by more than 25 degrees. The angle 220 may be about 30 degrees.

The blade may be bent by being pressed by the base plate 108 against a lower surface 224 of the top cap or a portion of the lower surface 224. The blade 110 may be pressed against the lower surface 224 of the top cap 106 or the portion thereof such that the blade has a radius of curvature over a curved portion 226 of the blade 110 of between 5 and 15 millimeters. The radius of the curvature of the curved portion 226 may be between 8.5 and 10.25 millimeters. The radius of the curvature of the curved portion 226 may be between 9 and 10 millimeters. The radius of the curvature of the curved portion 226 may be about 9.5 millimeters.

The lower surface 224 or a portion thereof may be a curved surface (e.g., a concave curved surface). The base plate 108 may have an upper surface 228, and the blade 110 may be received between the upper surface 228 and the curved lower surface 224 (i.e., pressed against the lower surface 224 by the upper surface 228). The radius of the curvature of the lower curved surface 224 may be between 5 and 15 millimeters. The radius of the curvature of the lower curved surface 224 may be between 8.5 and 10.25 millimeters. The radius of the curvature of the lower curved surface 224 may be between 9 and 10 millimeters. The radius of the curvature of the lower curved surface 224 may be about 9.5 millimeters. The radius of the curvature of the upper curved surface 228 may be about the same as the radius of the curvature of the lower curved surface 224.

The upper surface 228 or a portion thereof may be, as in the illustrated example of FIG. 4, a curved surface (e.g., a convex curved surface). The radius of the curvature of the upper curved surface 228 may be between 5 and 15 millimeters. The radius of the curvature of the upper curved surface 228 may be between 8.5 and 10.25 millimeters. The radius of the curvature of the upper curved surface 228 may be between 9 and 10 millimeters. The radius of the curvature of the upper curved surface 228 may be about 9.5 millimeters. The radius of the curvature of the upper curved surface 228 may be about the same as the radius of the curvature of the lower curved surface 224.

Bending the blade 110 in this manner may introduce tension on the blade 110. Tension may contribute to a more rigid blade 110 (e.g., in connection with a short free-end distance 172 and/or a short clamp distance 170). Tension may allow for a larger blade exposure 200, blade gap 190, and/or guard span 204 without an undesirable shave experience.

### Hair Evacuation

In accordance with this aspect, the safety razor 100 is shaped to have large and ergonomically shaped evacuation channels 230 (e.g., for hair, cream, etc.). This aspect may be used by itself or in combination with one or more of the other aspects set out herein.

Large and ergonomically shaped evacuation channels 230 will contribute to a quicker and/or safer shave. Large and ergonomically shaped hair evacuation channels 230 may reduce clogging due to poor evacuation of hair (e.g., less need for rinsing and/or less nicks and irritated skin).

The evacuation channels 230 extend between an inlet 232 and an outlet 234. As exemplified in FIG. 5, the inlet 232 may be formed between the base plate 108 and the blade 110 held in the head 116. The outlet 234 may be formed in a lower end of the base plate 108. The channel 230 may have an inner wall 240 and an outer wall 238. The inner wall 240 may be shorter than the outer wall 238 (i.e., the inner wall 240 extending between a bottom 242 of the inlet 232 and a front 244 of the outlet 234).

As exemplified in FIG. 1, the safety razor 100 may include a single inlet 232 extending generally the full length of the blade edge 150. The lower lip 242 of the inlet 232 may be linear and/or without upward projections. This may facilitate the movement of hair in through the inlet 232.

The hair evacuation channels 230 may have generally smooth walls 248. For example, the outer wall 238 may have no corners, or only a blade corner 250 where the blade 110 meets the base plate 108. The base plate 108 may be shaped with a clamping portion 252 extending away from the blade corner 250 at an angle 254 that is greater than 90 degrees, greater than 100 degrees, or greater than 110 degrees.

### Weight

In accordance with this aspect, the safety razor 100 has a light weight. This aspect may be used by itself or in combination with one or more of the other aspects set out herein.

An advantage of this aspect is that the safety razor 100 may be easier to use and/or have a better hand feel.

The safety razor 100 may have a total weight, including the blade (e.g., a stainless steel blade), of less than 60 grams. The safety razor 100 may have a total weight of less than 40 grams. The safety razor 100 may have a total weight of about 37 grams.

The top cap 106, base plate 108, and/or handle 140 may be made primarily of a lightweight metal (e.g., aluminum). More than 50 percent of the top cap 106, the base plate 108, and/or the handle 140 may be made of the lightweight metal. More than 90 percent of the top cap 106, the base plate 108, and/or the handle 140 may be made of the lightweight metal.

The top cap 106, base plate 108, and/or handle 140 may be coated with a coating (e.g., a protective coating). For example, the coating may be an anodized coating (e.g., Type II anodizing).

### Thrust Bushing

In accordance with this aspect, the base plate 108 includes a thrust bushing insert 260. This aspect may be used by itself or in combination with one or more of the other aspects set out herein.

An advantage of this aspect is that the thrust bushing insert 260 may reduce friction between the handle and the base plate during tightening of the handle and/or improve the durability of the safety razor 100.

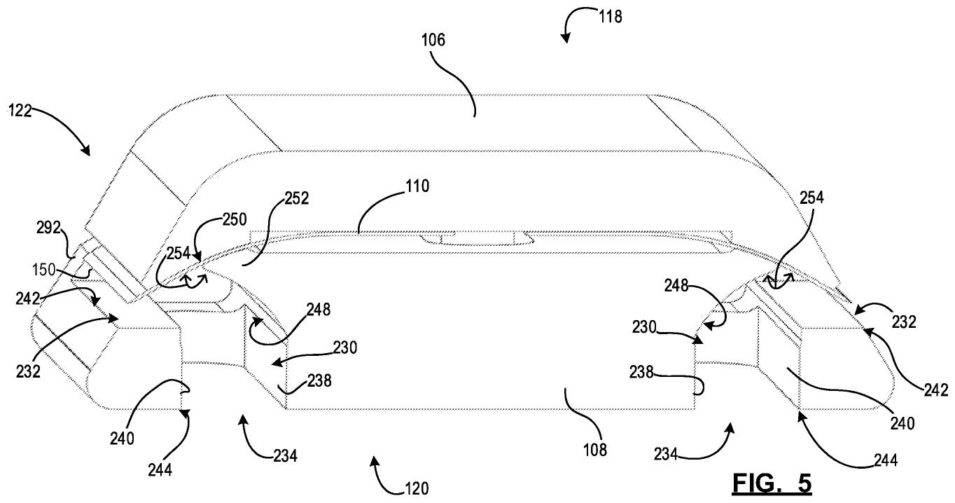

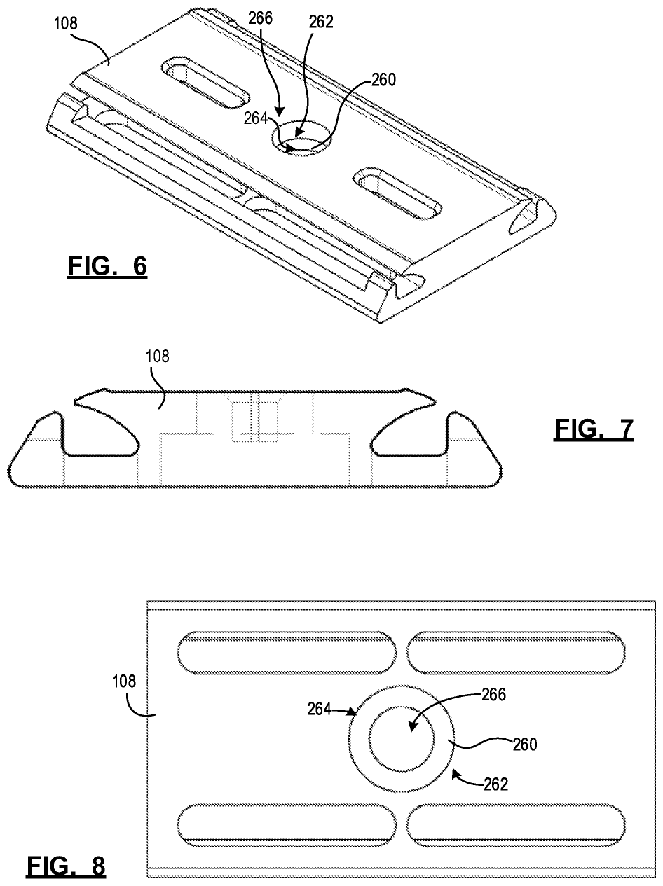

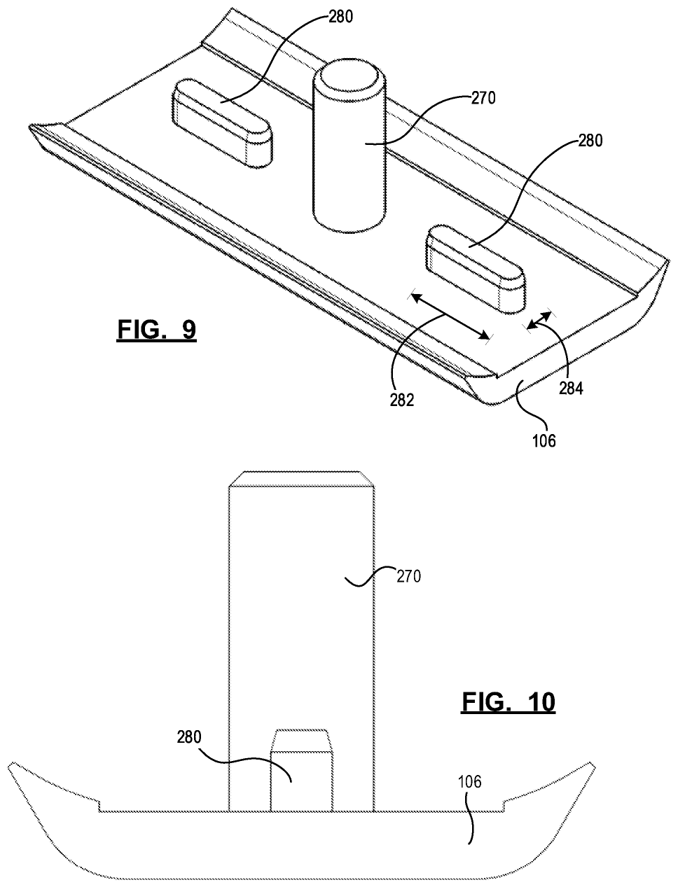

As exemplified in FIGS. 6 to 8, the thrust bushing insert 260 is received in an opening 262 in an underside of the base plate 108. The thrust bushing surrounds the lower end 264 of an aperture 266 through the base plate 108. The aperture 266 through the base plate is provided for a retention feature 270 of the top cap 106 (exemplified in FIGS. 9 and 10) to extend through the base plate 108. The retention feature 270 of the top cap 106 may be a threaded projection to be received inside a threaded aperture in the proximate end 146 (FIG. 1) of the handle 140. Securing the handle 140 on the retention feature 270 of the top cap 106 when the retention feature 270 is received through the aperture 266 holds the head 116 together (e.g., holding the razor blade 110 when the razor blade 110 is received in the head 116).

The thrust bushing insert 260 may be made primarily of a first material and the base plate 108 and/or the proximate portion 146 of the handle 140 may be primarily made of a second material that is different from the first material. Using different materials may reduce wear (e.g., reduce wear between the handle and the base plate).

In some examples, the first and second materials are both primarily metals. One of the first material or the second material may be formed of a metal with a low coefficient of friction (e.g., a low coefficient of friction and a high hardness and a high corrosion resistance). For example, one of the first material or the second material may primarily be tungsten (e.g., the thrust bushing insert 260 may be primarily made of tungsten). In some examples, the second material is primarily one of aluminum, brass, stainless steel, and titanium.

The thrust bushing insert 260 may be arranged in the opening 262 such that a lower surface of the thrust bushing insert is flush with a lower surface of the base plate 108.

The retention feature 270 may be shaped to receive the handle 140 such that the handle 140 is tightened against the thrust bushing insert 260 to tighten the base plate 108 against the top cap 106. For example, the handle 140 may include an opening in the proximal end 146 that is sized and shaped to receive the entire lower end of the retention feature 270 therein so that a top surface of the handle 140 may be advanced against the thrust bushing 260 when the lower end of the retention feature 270 is received in the opening in the top of the proximal end 146 of the handle 140. The opening in the handle 140 and the retention feature 270 may each be threaded such that the handle 140 is rotationally tightened against the thrust bushing 260.

### Locator Tabs

In accordance with this aspect, the safety razor 100 includes a tab 280 to hold the razor blade 110 in place between the top cap 106 and the base plate 108 when the razor blade 110 is received in the head 116. This aspect may be used by itself or in combination with one or more of the other aspects set out herein.

The tab 280 may result in a greater level of stability than the use of cylindrical pins or other retaining features. The tab 280 may make it easier for the user to remove the razor blade 110 from the safety razor 100 that if the razor blade 110 is mounted on cylindrical pins or other retaining features. In some examples, the safety razor 100 may include a plurality of tabs 280 (e.g., two, as exemplified in FIGS. 9 and 10).

The tabs 280 are elongated projections, and project from one of the top cap 106 or the base plate 108 (e.g., the tabs 280 may be projections from the top cap 106, as in the illustrated example). The tabs 280 each have a length 282 that is at least 2 times the width 284. The tabs 280 may each have a length 282 that is at least 5 times the width 284. The tabs 280 may each be arranged to be received in the elongated transverse slot 156 of the razor blade 110.

The tabs 280 may be centrally positioned between the front end 122 and the rear end 124 of the head 116 (e.g., to be received in a centrally-located slot in the blade 110). The tabs 280 may be arranged in a symmetrical pattern between the lateral sides 126, 128 of the head 116. In some examples, the base plate 108 includes apertures 296 shaped and positioned to receive lower ends of the tabs 280 when the head 116 is assembled.

### Enclosed Blade Sides

In accordance with this aspect, the top cap 106 and the base plate 108 are shaped to extend out beyond the sides 290 (FIG. 3) of the blade 110 to cover the sides 290 of the blade 110 when the blade 110 is received in the assembled head 116. This aspect may be used by itself or in combination with one or more of the other aspects set out herein.

This aspect may facilitate use of the safety razor 100 without accidental contact between the blade sides and skin of the user.

As exemplified in FIGS. 1 to 3, the top cap 106 and/or base plate 108 may have a width 294 from lateral side 126 to lateral side 128 that is greater than the length 298 of the blade 110.

The safety razor 100 may also or alternatively include side guards 292 at the lateral sides of the inlet 232, as exemplified in FIG. 6. In some examples, the side guards may be at the sides 290 of the blade 110 when the blade 110 is received in the head 116, as exemplified in FIG. 1.

The present invention has been described here by way of example only. Various modification and variations may be made to these exemplary embodiments without departing from the scope of the invention, which is limited only by the appended claims.

1. A safety razor, comprising:
a. a handle;
b. a base plate having an upper surface; and
c. a top cap having a lower surface with a lateral portion having a concave cap curvature, the cap curvature having a cap radius of less than 15 millimeters, the top cap configured to be secured to the base plate to hold a removeable double-edged razor blade between the upper surface and the lower surface, with the handle extending from the joined base plate and top cap for use in manipulating the joined base plate and top cap, and
d. wherein the base plate and the top cap are shaped to hold the removeable double-edged razor blade between the upper surface and the lower surface such that a lateral portion of the razor blade takes on a blade curvature having a blade radius approximately equal to the cap radius.

2. The safety razor of claim 1, wherein the upper surface of the base plate has a lateral portion having a convex plate curvature, the convex plate curvature having a plate radius approximately equal to the cap radius.

3. The safety razor of claim 1, wherein the base plate and the top cap are shaped to hold the razor blade between the upper surface and the lower surface such that an edge-bearing portion of the blade is deflected by an angle of at least 20 degrees relative to a central portion of the razor blade.

4. The safety razor of claim 1, wherein the base plate and the top cap are shaped to hold the razor blade between the upper surface and the lower surface such that a central portion of the razor blade is planar.

5. The safety razor of claim 1, wherein the razor blade has a width of less than 30 millimeters and the base plate and the top cap are shaped to hold the razor blade between the upper surface and the lower surface such that the clamp distance is less than 3 millimeters.

6. The safety razor of claim 1, wherein the razor blade has a width of less than 30 millimeters and the base plate and the top cap are shaped to hold the razor blade between the upper surface and the lower surface such that the free-end distance is less than 1 millimeter.

7. The safety razor of claim 1, wherein the razor blade has a width of less than 30 millimeters and the base plate and the top cap are shaped to hold the razor blade between the upper surface and the lower surface such that a blade exposure is less than 0.075 millimeters.

8. The safety razor of claim 1, wherein the base plate and the top cap are shaped to hold the razor blade between the upper surface and the lower surface such that the blade gap is between 1 millimeter and 0.5 millimeters.

9. The safety razor of claim 1, wherein the base plate and the top cap are shaped to hold the razor blade between the upper surface and the lower surface such that the guard span is less than 1 millimeter.

10. The safety razor of claim 1, wherein the base plate and the top cap are shaped to hold the razor blade between the upper surface and the lower surface such that the guard span is less than two times the size of the blade gap.

11. A safety razor, comprising:
a. a handle;
b. a base plate having an upper surface and a plate lateral surface; and
c. a top cap having a lower surface and a cap lateral surface, the top cap configured to be secured to the base plate to hold a removeable double-edged razor blade between the upper surface and the lower surface, with the handle extending from the joined base plate and top cap for use in manipulating the joined base plate and top cap, and
d. wherein the base plate and the top cap are shaped to hold the removeable double-edged razor blade between the upper surface and the lower surface such that the safety razor has a shave plane parallel to the cap lateral surface and tangential to the plate lateral surface, and wherein the cap lateral surface has a height that is at least twice the size of the blade gap.

12. The safety razor of claim 11, wherein the plate lateral surface is also planar, and the base plate and the top cap are shaped to hold a removeable double-edged razor blade between the upper surface and the lower surface such that the plate lateral surface is not parallel to the cap lateral surface.

13. The safety razor of claim 11, wherein the base plate and the top cap are shaped to hold a removeable double-edged razor blade between the upper surface and the lower surface such that a plane parallel to the plate lateral surface is angled by less than 5 degrees relative to a plane parallel to the cap lateral surface.

14. The safety razor of claim 11, wherein the razor blade has a width of less than 30 millimeters and the base plate and the top cap are shaped to hold the razor blade between the upper surface and the lower surface such that a blade exposure is between 1 millimeter and 0.01 millimeters.

15. The safety razor of claim 11, wherein the base plate and the top cap are shaped to hold the razor blade between the upper surface and the lower surface such that the guard span is less than 1.25 millimeters.

16. A safety razor, comprising:
a. a handle;
b. a top cap having a lower surface and a retention feature to receive a portion of the handle;
c. a base plate having an upper surface;
d. a thrust bushing insert received in an opening in the base plate; and
e. wherein the base plate and the top cap are shaped to hold a removeable double-edged razor blade between the upper surface and the lower surface when drawn together, and to be drawn together by tightening the portion of the handle onto the retention feature and against the thrust bushing insert, and
f. wherein the thrust bushing insert is made of a first material and the portion of the handle is made of a second material different from the first material.

17. The safety razor of claim 16, wherein the first and second materials are each metals.

18. The safety razor of claim 16, wherein one of the first and second materials is mainly tungsten.

19. The safety razor of claim 16, wherein the first material is mainly tungsten.

20. The safety razor of claim 19, wherein the second material is mainly one of aluminum, brass, stainless steel, and titanium.
